(19) United States
(12) Patent Application Publication
(10) Pub. No.: US 2013/0064939 A1
(43) Pub. Date: Mar. 14, 2013

(54) SMOKE-IMPREGNATED FOOD CASINGS BASED ON CELLULOSE AND METHODS FOR REDUCING DISCOLORATIONS ON AND IN THE SURFACE OF SUCH CASINGS

(71) Applicants: HEINRICH HENZE-WETHKAMP, WALSRODE (DE); ANTON KRALLMANN, BAD FALLINGBOSTEL (DE)

(72) Inventors: HEINRICH HENZE-WETHKAMP, WALSRODE (DE); ANTON KRALLMANN, BAD FALLINGBOSTEL (DE)

(73) Assignee: CASETECH GMBH, Bomlitz (DE)

(21) Appl. No.: 13/438,486

(22) Filed: Apr. 3, 2012

(30) Foreign Application Priority Data
Sep. 8, 2011 (EP) 11 007 303.8

(51) Int. Cl. A22C 13/00

(52) U.S. Cl. 426/135; 426/262; 426/268

(57) ABSTRACT

Smoke-impregnated food casings based on cellulose and also methods for reducing discolorations on and in the surface of such casings are provided.

### CROSS-REFERENCE TO RELATED APPLICATIONS

This application claims the benefit of European Patent Application Number 11 007 303.8 filed on Sep. 8, 2011, the disclosure of which is hereby expressly incorporated by reference in its entirety and hereby expressly made a portion of this application.

### BACKGROUND OF THE INVENTION

1. Field of the Invention

The present invention relates to smoke-impregnated food casings based on cellulose and also to methods for reducing discolorations on and in the surface of such casings. The casings used are made of pure cellulose or of cellulose with an additional fiber paper reinforcement in the interior (then called fibrous casings). Furthermore, the cellulose fiber skin may be equipped with an additional barrier layer in the form of a PVDC coating. Textile tubular casings with cellulose (textile skin) can also be used. These casings have been impregnated with liquid smoke.

2. Description of the Related Art

As applied to raw sausages, smoking is carried out traditionally on hygiene grounds. Moreover, in many applications, a smoked aroma and smoked flavor to the sausage is conducive to sales. The traditional smoking methods can be replaced by equipping the casing with liquid smoke.

For the transfer of smoke flavor and smoke aroma to sausage products it is possible, alongside the methods of traditional smoking and of smoking using liquid smoke, to impregnate sausage casings with liquid smoke directly. During the ripening or cooking procedure, the sausage casings then transfer the color, aroma, and flavor substances to the stuffing. In addition to the sensory enhancement of the sausage products, the transfer of smoke serves hygiene purposes. Molds and unwanted bacteria are killed, or their growth inhibited, by smoke constituents possessing fungicidal and bactericidal activity.

The desired brown coloration of the emulsion surface is brought about above all by the Maillard reaction. In the case of (liquid) smoke, these are carbonyl compounds which react with the amino acids of the proteins in the sausage emulsion. A further cause of the brown coloration lies in the inherent color of the primary and secondary pyrrolysis products that are formed during smoke production. In the case of sausage casings impregnated with liquid smoke, the colorations are particularly strongly pronounced. Liquid smoke is obtained by controlled pyrrolysis of wood material and subsequent condensation of smoke constituents with water. In further production steps, the condensed smoke is purified and, if required, concentrated. The procedure of producing liquid smoke has already been described in a multiplicity of patents. The varieties of liquid smoke possess pale brown to very dark or black intrinsic colors.

Described in the prior art are numerous methods for producing sausage casings impregnated with liquid smoke. The liquid smoke here serves as both a coloring substance and a flavoring substance for sausage products (U.S. Pat. No. 4,604,309, U.S. Pat. No. 4,442,868, and U.S. Pat. No. 4,446,167). The patents frequently describe the application of basic liquid smoke, which is said to produce substantially stronger coloring than acidic liquid smoke (U.S. Pat. No. 6,032,701).

Smoke-impregnated skin varieties continually have problems with the occurrence of black spots within the skin surface. The black spots are a color reaction between the phenolic fractions of the smoke mixture and the metal ions present in the skin itself. Through contact with metal rolls, these metal ions may get onto or into the tubular casing or, in the course of the production of the viscose, into the skin. The discolorations are not visible directly after the smoke solution has been applied to the skin, but instead come to light here only after some time. Hence a few days or even several weeks may pass before this reaction becomes visible in the form of black spots with a size of 1 to 10 mm or more mm.

Patent U.S. Pat. No. 4,500,576 to Union Carbide (filed 1983) with the title “Inhibition of discoloration on cellulose food casings” attempted in a variety of ways to solve the spotting problem. From that specification it is known that trisodium phosphate in particular, as well as EDTA, is able to act as a complexing agent and hence may contribute to avoidance of the color reaction between the phenol fraction of the smoke mixture and the iron ions in the cellulose fiber skin. According to that patent specification, the addition of trisodium phosphate to the smoke can reduce the number of spots.

During manufacture, the use of trisodium phosphate gives rise to the following problem: in water it is possible to dissolve not more than 10% by weight of trisodium phosphate. In the case of a liquid smoke composition with an oil base, the smoke mixture is generally able to take up not more than 5% by weight of water with additive. At higher concentrations of water in the oily smoke mixture, there are instances of separation, and the smoke mixture precipitates. One way to transfer a somewhat greater amount of phosphate onto or into the food casing is to apply the smoke mixture containing trisodium phosphate to both sides of the casing. This carries with it the disadvantage of an additional workstep. In addition, the effectiveness of the trisodium phosphate on the outside is far from as great as on the inside of the food casing.

### SUMMARY OF THE INVENTION

The object, therefore, was to provide a uniformly colored food casing, based on cellulose, that is able to transfer smoked aroma and smoked flavor to a food located inside it. Moreover, the colored food casing based on cellulose is to possess a very uniform coloring and very few, if any, optical defects. Optical defects may be black spots which emerge after the liquid smoke composition has been applied. Following removal of the cellulose fiber skin, the stuffed sausages are to exhibit a very uniform color on the sausage surface. It would be desirable, moreover, for the object to be achievable with as few (additional) worksteps as possible in the production of the smoke-impregnated sausage casings.

### DETAILED DESCRIPTION OF THE PREFERRED EMBODIMENT

The object is achieved by means of a liquid smoke mixture which along with the predominant flavoring and coloring components also comprises a specific phosphate, namely dipotassium hydrogen phosphate.

The present invention accordingly provides a tubular, cellulose-based food casing treated with a composition comprising liquid smoke, characterized in that the composition comprises dipotassium hydrogen phosphate (K₂HPO₄ or its hydrates).

The advantage according to the invention, then, is that in water it is possible to dissolve not only the maximum fraction of 10% by weight of trisodium phosphate, but instead up to 25% by weight or more of dipotassium hydrogen phosphate. The fraction of phosphate ions as complexing agents in the liquid smoke composition can therefore be increased significantly, especially in the case of predominantly oily smoke mixtures in which, naturally, the water-soluble phosphates are not readily soluble.

In one preferred embodiment of the invention, the composition with which the food casing is treated comprises at least one humectant selected from propanediol, glycerol, and polysorbates. A humectant may be used in order to counter the composition comprising liquid smoke becoming sticky. In this context, in general, up to 15% by weight, preferably 5-12% by weight, of polysorbates or up to 30% by weight, preferably 15-25% by weight, of propanediol or glycerol is sufficient to achieve the desired effect. The use of 15-25% by weight of propanediol, based on the composition comprising liquid smoke, is particularly preferred.

It is likewise preferred if the composition comprising liquid smoke in the food casing of the invention has a pH of 4 to 7, preferably a pH of 5 to 6. Given that commercially available liquid smoke mixtures which are used as a basis for the compositions used in accordance with the invention inherently have in general a low pH, the pH of the composition is adjusted or raised by means of basic agents, typically by means of NaOH. Through the inventive use of dipotassium hydrogen phosphate, the amount of NaOH, for example, as a basic agent can now be advantageously reduced.

The liquid smoke that is present in the composition used in accordance with the invention may comprise as its main constituent an oily phase or aqueous phase. As further constituents, the liquid smoke comprises condensed wood smoke, which is dissolved in the oily or aqueous phase or, where both an oily and an aqueous phase are present, may be dissolved in both phases.

As already mentioned above, in one preferred embodiment of the invention, the food casing is characterized in that the main constituent of the liquid smoke is an oily phase.

The composition in the food casing of the invention may be applied to the inside and/or outside of the casing. In this context, the composition may be drawn at least partly, possibly even completely, into the inside and/or outside of the casing. In one preferred embodiment, the composition is applied only to the inside of the casing, in order to save on the additional workstep of application to the outside. This advantage is difficult or impossible to achieve when using phosphates other than dipotassium hydrogen phosphate, since with dipotassium hydrogen phosphate it is possible to provide significantly higher concentrations of phosphate, especially in oily smoke mixtures.

In one preferred embodiment of the invention, the composition may indeed comprise one or more other phosphates, but the ratio of % by weight of dipotassium hydrogen phosphate (K₂HPO₄) to the sum of the % by weight of the one or more other phosphates (calculated in each case as anhydrate, i.e., broadly, K₃PO₄, KH₂PO₄, Na₃PO₄, Na₂HPO₄ and/or NaH₂PO₄), ought to be greater than 1, the % by weight being based in each case on the composition. The composition may also contain no other phosphates at all apart from dipotassium hydrogen phosphate.

In a typical and preferred embodiment of the invention, the composition contains 2% to 10%, preferably 4% to 8%, by weight of water and 1% to 5%, preferably 2% to 4%, by weight of dipotassium hydrogen phosphate (calculated as K₂HPO₄ in the event hydrates are used) in dissolved form, the weight ratio of water to dipotassium hydrogen phosphate being between 85:15 and 65:35, preferably between 80:20 and 70:30% by weight.

The tubular, cellulose-based food casing of the invention may be selected more particularly from cellulose skin, cellulose fiber skin or cellulose-based textile skin.

In one particular embodiment of the invention, the food casing may be a multilayer casing. In that case the food casing may have one or more layers having water vapor barrier properties, with a permeability preferably of less than 50 g/m²d, preferably less than 40 g/m²d, measured in accordance with DIN/EN ISO 15106 at 85% r.h. and 23° C., and/or one or more layers having oxygen barrier properties, with a permeability preferably of less than 50 cm³/m²d·bar, preferably less than 40 cm³/m²d·bar, measured in accordance with DIN 53380 at 75% r.h. and 23° C.

Additionally provided by the present invention is a method for reducing discolorations on and in the surface of a tubular, cellulose-based food casing, the inside and/or outside of the food casing, preferably only the inside of the food casing, being treated with a composition comprising liquid smoke, characterized in that dipotassium hydrogen phosphate (K₂HPO₄ or its hydrates) is added to the composition.

As already mentioned above, at least one humectant selected from propanediol, glycerol, and polysorbates, preferably in the amounts specified above, may be added to the composition with which the food casing is treated in order to counteract the composition comprising liquid smoke becoming sticky. The use of 15-25% by weight of propanediol, based on the composition comprising liquid smoke, is particularly preferred.

As far as the pH is concerned, it is preferred for the composition comprising liquid smoke in the food casing of the invention to have a pH of 4 to 7, preferably a pH of 5 to 6, or to be formulated in this range.

In one preferred embodiment of the invention, the method is carried out such that the composition contains 2% to 10%, preferably 4% to 8%, by weight of water and 1% to 5%, preferably 2% to 4%, by weight of dipotassium hydrogen phosphate (calculated as K₂HPO₄ in the event hydrates are used) in dissolved form, the weight ratio of water to dipotassium hydrogen phosphate being between 85:15 and 65:35, preferably between 80:20 and 70:30% by weight. For this purpose, typically, a commercially available liquid smoke with an oily base, and an aqueous dipotassium hydrogen phosphate solution, are dissolved or mixed with one another, together with any further constituents intended, in so homogeneous a way as to obtain a composition as specified above.

Additionally provided with the present invention is the use of dipotassium hydrogen phosphate (K₂HPO₄ or its hydrates) as a constituent of a tubular, cellulose-based food casing treated with a composition comprising liquid smoke, the dipotassium hydrogen phosphate being present in the composition.

The present invention also provides the use of dipotassium hydrogen phosphate (K₂HPO₄ or its hydrates) for avoiding discolorations on and in the surface of tubular, cellulose-based food casings treated with a composition comprising liquid smoke.

The invention also provides a method for producing a tubular, cellulose-based food casing, the food casing being treated with a composition comprising liquid smoke, characterized in that the composition comprises dipotassium hydrogen phosphate.

The dipotassium hydrogen phosphate can also be applied in an extra step prior to shirring in the form of a dipotassium hydrogen phosphate solution and optionally comprising further constituents of the composition described above, followed by the application of the liquid smoke and of those constituents of the composition not applied initially. Following application, the tubular casing can be shirred in conventional ways and with the customary, known techniques.

The tubular casing may optionally have one or more barrier layers against water and/or against oxygen.

A typical mixture for impregnating the inside may consist of the following constituents: a) 15-76% by weight of a natural smoke aroma in the form of liquid smoke, produced from freshly evolved smoke from natural hardwoods, having a pH of about 2.2-3.2, a smoke aroma content of 22-30 mg/ml, and a carbonyl content of 25-35% (e.g., RA® Enviro 24 from the manufacturer Red Arrow), b) 10-30% by weight of propanediol, c) 3-8% by weight of a 10-70% strength aqueous dipotassium hydrogen phosphate solution, and d) 0.5-5% by weight of a 20-80% strength aqueous sodium hydroxide solution.

The smoke-impregnated tubular films produced in this way are particularly suitable for small-sausage, cooked-ham or scolded-emulsion-sausage applications, since with this skin there is no need for smoking in a smoking chamber.

### EXAMPLES

The inventive and comparative examples in Table 1 are intended to illustrate the invention designated in accordance with the claims.

The casings, in order to increase the storage life of the finished sausages, the barrier properties, comprise a water barrier and oxygen barrier layer of a PVDC coating in a thickness of 10 μm.

TABLE 1

| Recipe for smoke mixture applied | Recipe 1 | Recipe 2 | Recipe 3 |
|---|---|---|---|
| via internal bubble | [wt. %] | [wt. %] | [wt. %] |
| Enviro 24/Red Arrow | 75 | 75 | 80 |
| 10% strength trisodium phosphate | 0 | 5 | 0 |
| solution | | | |
| 60% strength dipotassium hydrogen | 5 | 0 | 0 |
| phosphate solution | | | |
| Propanediol | 18 | 18 | 18 |
| 50% strength NaOH solution | 2 | 2 | 2 |
| Amount taken up to dry skin weight | 30 | 30 | 30 |
| Amount of pure phosphate, based on | 0.9 | 0.075 | 0 |
| initial weight of untreated skin | | | |

### Tests:

### 1. Counting the Number of Discoloration Spots:

The skin varieties produced in accordance with the examples are laid flat and inspected on both sides. The inspection is to include a count of the number of color reactions in the form of black spots. They are included in the count from a minimum size of 1 mm in diameter.

The counted amount of the discolorations is then transferred to the list—the greater the number of discolorations, the poorer the scoring.

2. Resistance to Discolorations on Iron Contact

Part of the area of the smoke-impregnated tubular casing is weighted down in the flat-laid state with a piece of iron (here, flat iron of grade St 37 with dimensions of 80 mm length, 40 mm width, and 8 mm thickness). The weighting is limited in time to 30 minutes at ambient temperature. The substrate on which the skin is lying is not made of metal. When the test time has expired, the iron is removed and an evaluation is made of the contact area. If the color reaction is such that the area contacted and also the bottom ply of the tubular casing exhibit black discoloration, a score of 6 is awarded. If there has been no discoloration at all after a contact time of 30 minutes, a score of 1 is awarded.

The inventive example and the corresponding comparative example each have the same amount of phosphate PO₄.

### Inventive Example 1 (IE1)

A size-80 cellulose fiber skin (commercial product Walsroder® FRO 80, manufacturer Case Tech GmbH) has in accordance with the invention taken up 30% by weight of above mixture 1 on the inside, using the bubble technique, in each case based on dry skin weight.

### Comparative Example 1a (CE1a)

The inside of the skin used in inventive example 1 is furnished with mixture 2 in an amount of 30% by weight.

### Comparative Example 1b (CE1b)

The inside of the skin used in inventive example 1 is furnished with mixture 3 in an amount of 30% by weight.

### Inventive Example 2 (1E2)

The externally PVDC-coated cellulose fiber skin (commercial product Walsroder® FVP 90, manufacturer Case Tech GmbH) has in accordance with the invention taken up 30% by weight of above mixture 1 on the inside, using the bubble technique, in each case based on dry skin weight.

### Comparative Example 2a (CE2a)

The inside of the skin used in inventive example 2 is furnished with mixture 2 with the same amount as in inventive example 2. On the tubular casing with the external coating, the second test cannot be carried out, since it is impossible to observe the color reaction through the barrier layer.

### Comparative Example 2b (CE2b)

The inside of the skin used in inventive example 2 is furnished with mixture 3 with the same amount as in inventive example 2. On the tubular casing with the external coating, the second test cannot be carried out, since it is impossible to observe the color reaction through the barrier layer.

### Inventive Example 3 (1E3)

The commercial product peelable cellulose skin in size 35 has taken up 30% by weight of above mixture 1 on the inside, using the bubble technique, in each case based on dry skin weight.

### Comparative Example 3a (CE3a)

The inside of the skin used in inventive example 3 is furnished with mixture 2 with the same amounts as in inventive example 3.

### Comparative Example 3b (CE3b)

The inside of the skin used in inventive example 3 is furnished with mixture 3 with the same amounts as in inventive example 3.

The result of the tests is collated in Table 2 below:

TABLE 2

| Specimen | | IE1 | CE1a | CE1b | IE2 | CE2a | CE2b | IE3 | CE3a | CE3b |
|---|---|---|---|---|---|---|---|---|---|---|
| Nominal size | | 80 | 80 | 80 | 90 | 90 | 90 | 35 | 35 | 35 |
| Number of | number | 0 | 10 | 15 | 0 | 12 | 17 | 0 | 5 | 18 |
| black spots | | | | | | | | | | |
| within 1 meter | | | | | | | | | | |
| Intensity of | score * | 1 | 4 | 5 | ** | ** | ** | 1 | 4 | 5 |
| discoloration | | | | | | | | | | |
| on iron contact | | | | | | | | | | |

* score-grade principle: 1 = very good, no spotting, 5 = deficient, very severe, extensive
** not applicable

What is claimed is:

1. A tubular, cellulose-based food casing treated with a composition comprising liquid smoke, wherein the composition comprises dipotassium hydrogen phosphate.

2. The food casing according to claim 1, wherein the composition comprises at least one humectant selected from the group consisting of propanediol, glycerol, and polysorbates.

3. The food casing according to claim 1, wherein the composition has a pH of 4 to 7.

4. The food casing according to claim 1, wherein the liquid smoke comprises as its main constituent an oily or aqueous phase and as further constituents condensed wood smoke dissolved in the oily and/or aqueous phase.

5. The food casing according to claim 4, wherein the main constituent of the liquid smoke is an oily phase.

6. The food casing according to claim 1, wherein the composition may comprise one or more other phosphates, provided a ratio of a % by weight of dipotassium hydrogen phosphate to a sum of a % by weight of the one or more other phosphates is greater than 1, the % by weight being based in each case on the composition.

7. The food casing according to claim 1, wherein the composition contains no other phosphates besides dipotassium hydrogen phosphate.

8. The food casing according to claim 1, wherein the composition contains 2% to 10% by weight of water and 1% to 5% by weight of dipotassium hydrogen phosphate in dissolved form, a weight ratio of water to dipotassium hydrogen phosphate being between 85:15 and 65:35.

9. The food casing according to claim 1, wherein the food casing is selected from the group consisting of cellulose skin, cellulose fiber skin and cellulose-based textile skin.

10. A method for reducing discolorations on and in a surface of a tubular, cellulose-based food casing, comprising:
treating an inside and/or outside of the food casing with a composition comprising liquid smoke, wherein dipotassium hydrogen phosphate is added to the composition.

11. The method according to claim 10, wherein a humectant selected from the group consisting of propanediol, glycerol, and polysorbates is added to the composition.

12. The method according to claim 10, wherein the composition is adjusted by means of a basic addition to a pH of 4 to 7.

13. The method according to claim 10, wherein the composition contains 2% to 10% by weight of water and 1% to 5% by weight of dipotassium hydrogen phosphate in dissolved form, a weight ratio of water to dipotassium hydrogen phosphate being between 85:15 and 65:35.
